(19) United States
(12) Patent Application Publication
(10) Pub. No.: US 2009/0128490 A1
(43) Pub. Date: May 21, 2009

(54) INPUT APPARATUS AND OPTICAL MOUSE FOR COMPUTER AND OPERATION METHOD THEREOF

(75) Inventors: Chin-Chung Kuo, Taipei (TW); Yih-Chieh Pan, Taipei (TW); Ling-Chen Chang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/247,207

(22) Filed: Oct. 7, 2008

(30) Foreign Application Priority Data
Nov. 19, 2007 (TW) 96143773

(51) Int. Cl. G06F 3/033

(52) U.S. Cl. 345/161; 345/166

(57) ABSTRACT

An input apparatus for a computer system comprises an image object, a prime motion detector, and a receiver. The prime motion detector has an image detection unit, a G-sensor, a mouse module, a switch unit, and a micro control unit (MCU). The image detection unit is used for detecting the image object. The switch is coupled to the G-sensor, the image detection unit and the mouse module. By such means, the switch unit can select to transmit an output of the mouse module, or transmit outputs of the G-sensor and the image detection unit to the MCU according to a selection signal. The MCU encodes an output of the switch unit to generate a detecting data to the receiver, and the receiver transmits the detecting data to the computer system for operating the computer system.

### CROSS-REFERENCE TO RELATED APPLICATION

This application claims the priority benefit of Taiwan application serial no. 96143773, filed on Nov. 19, 2007. The entirety of the above-mentioned patent application is hereby incorporated by reference herein and made a part of specification.

### BACKGROUND OF THE INVENTION

1. Field of the Invention

The present invention relates to an input apparatus for a computer system and an operation method thereof. More particularly, the present invention relates to an input apparatus for a computer system and an operation method thereof, in which a mouse operation method is combined.

2. Description of Related Art

A conventional input apparatus for a computer system includes a keyboard, a mouse, a touch panel, etc. Wherein, an input method of the keyboard is to press keys on the keyboard for data inputting, and the mouse and the touch panel are provided for a user to operate the computer system on a two-dimensional plane.

However, under some special circumstances, for example, computer game playing, the conventional input apparatus cannot provide a convenience input method. Therefore, a plurality of special input apparatus, such as a joystick is developed. Though operation of the computer game can be more interesting via such special input apparatus, it is still not so realistic.

Recently, some computer game providers have developed a technique for operating the computer game via action modes of the user in a three-dimensional space, so as to greatly improve interest and reality of the computer game. However, the conventional technique can only be applied to fixed hosts and game software, and is not suitable for all of the games, so that universalness and convenience thereof are greatly reduced.

### SUMMARY OF THE INVENTION

Accordingly, the present invention is directed to an input apparatus for a computer system, which can be universally applied to various computer systems and game software.

The present invention is directed to a multifunction optical mouse, which may have diversified operation modes, so that a user may operate a computer system with a more realistic manner.

The present invention is directed to a method for operating a computer system, by which a user may operate the computer system with a more intuitive and realistic manner.

The present invention provides an input apparatus for a computer system. The input apparatus comprises an image object, a prime motion detector, and a receiver. The image object has a plurality of positioning light sources for providing a light beam with a predetermined wavelength. Moreover, the prime motion detector includes an optical mouse module, a first G-sensor and an image detection unit, which may detect a movement state of the prime motion detector in a three-dimensional space or a two-dimensional plane, and output a first detecting data. Wherein, the image detection unit is used for receiving the light beam sent from the positioning light sources. The receiver is coupled to the computer system via a transmission interface, and receives the first detecting data output from the prime motion detector via a wireless transmission path. By such means, the receiver generates an operation command according to the first detecting data, and transmits the operation command to the computer system via the transmission interface for operating the computer system.

In an embodiment of the present invention, the input apparatus further includes an assistant motion detector having a second G-sensor, which may detect a movement state of the assistant motion detector in a three-dimensional space, and generate a second detecting data. Similarly, the assistant motion detector can transmit the second detecting data to the receiver via the wireless transmission path for operating the computer system.

The present invention provides a multifunction optical mouse suitable for a computer system. The optical mouse includes an image detection unit, a G-sensor, a mouse module, a switch unit and a micro control unit (MCU). The image detection unit is used for detecting a light beam with a first wavelength sent from an external light source, and outputting a relative position data. The G-sensor detects a movement state of the optical mouse in a three-dimensional space for outputting a G-sensing data on each coordinate axis in the three-dimensional space. Moreover, the mouse module is used for detecting a movement state of the optical mouse on a plane, and outputting a plane coordinates data. Wherein, output terminals of the image detection unit, the G-sensor and the mouse module are all coupled to the switch unit, and the switch unit selects to output one of the plane coordinates data, the relative position data and the G-sensing data according to a selection signal. Moreover, the MCU is coupled an output terminal of the switch unit for encoding an output of the switch unit, and generating a detecting data for operating the computer system.

In an embodiment of the present invention, when the selection signal is in a first state, the switch unit selects to transmit the outputs of the image detection unit and the G-sensor to the MCU.

Moreover, when the MCU detects that within a predetermined time, the G-sensing data on each coordinate axis in the three-dimensional space output from the G-sensor is maintained within a predetermined range, the MCU switches the selection signal to a second state, so that the switch unit may select to transmit the plane coordinates data to the MCU.

In another embodiment, when the MCU detects that the G-sensing data on a height-axis in the three-dimensional space output from the G-sensor is maintained within a predetermined range, the MCU switches the selection signal to a second state, so that the switch unit may select to transmit the plane coordinates data to the MCU.

In another embodiment of the present invention, the prime motion detector further includes a touch switch coupled to the switch unit. When the touch switch is disabled, the selection signal is then output in the first state, so that the switch unit selects to transmit the relative position data and the G-sensing data to the MCU. Comparatively, when the touch switch is enabled, the selection signal is then output in the second state, so that the switch unit selects to transmit the plane coordinates data to the MCU.

Moreover, in the present invention, a gate switch can be applied to substitute the touch switch. Wherein, when the gate switch is closed, the gate switch outputs the selection signal in the first state, so that the switch unit selects to transmit the relative position data and the G-sensing data to the MCU. Moreover, when the gate switch is opened, the gate switch outputs the selection signal in the second state, so that the switch unit selects to transmit the plane coordinates data to the MCU.

In an embodiment of the present invention, the mouse module includes a light-emitting source, an optical lens and a light-sensing unit. The light-emitting source provides a light beam having a predetermined wavelength, and the optical lens is disposed at an output terminal of the light-emitting source for focusing the light beam having the predetermined wavelength. Moreover, an output terminal of the light-sensing unit is coupled to an input terminal of the switch unit. The light-sensing unit is used for sensing a reflection light of the light beam having the predetermined wavelength, and outputting the plane coordinates data to the switch unit.

When a second sensor does not sense a reflection light of a light beam having a second wavelength, the selection signal is in a first state, so that the switch unit selects to transmit the relative position data and the G-sensing data to the MCU. When the second sensor senses the reflection light of the light beam having the second wavelength, the selection signal is in a second state, to that the switch unit selects to transmit the plane coordinates data to the MCU.

The present invention provides a method for operating a computer system. The method can be described as follows. First, a G-sensor is applied for detecting a movement state of an operation part in a three-dimensional space, and generating a G-sensing data corresponding to each coordinate axis of the three-dimensional space. Next, relative positions between a plurality of positioning light sources and the operation terminal are detected to generate a relative position data. When the operation part is judged to be only moved in a two-dimensional plane, a movement state of the operation part in the two-dimensional plan is detected to generate a plane coordinates data. Moreover, the plane coordinates data is encoded, or the G-sensing data and the relative position data are encoded to generate a detecting data for operating the computer system.

In an embodiment of the present invention, the method further includes transmitting the detecting data from the operation part to a receiver via a wireless transmission path, and transmitting the detecting data from the receiver to a computer system via a transmission interface, so as to operate the computer system according to the detecting data.

Since the input apparatus of the present invention includes a prime motion detector having an image detection unit and a G-sensor, which may detect a movement state of the prime motion detector in the three-dimensional space. Therefore, a user may operate the computer system with a more intuitive, realistic and less limitation manner. Moreover, in the present invention, a receiver is applied, and is coupled to the computer system via a universal transmission interface. By such means, the present invention can be applied to various computer application software or computer games.

Moreover, since the mouse module is applied for the user to operate the computer system via different manners, so that utilization of the present invention can be more flexible and practicable.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating an input apparatus of a computer system according to a preferred embodiment of the present invention.

FIG. 2A is a top view of a prime motion detector according to a first embodiment of the present invention.

FIG. 2B is a side view of a prime motion detector according to a first embodiment of the present invention.

FIG. 3 is an internal circuit block diagram of a prime motion detector according to a first embodiment of the present invention.

FIG. 4 is a structural diagram of a mouse module.

FIG. 5 is a flowchart illustrating a method for detecting a movement state of a prime motion detector according to a first embodiment of the present invention.

FIGS. 6A and 6B are waveform diagrams of G-sensing data on different coordinates axes in a three-dimensional space.

FIG. 7A and FIG. 7B are side views of a prime motion detector according to a third embodiment of the present invention.

FIG. 8 is an internal circuit block diagram of a prime motion detector according to a third embodiment of the present invention.

FIG. 9 is a flowchart illustrating a method for generating a detecting data according to a third embodiment of the present invention.

FIG. 10A and FIG. 10B are side views of a prime motion detector according to a fourth embodiment of the present invention.

FIG. 11 is an internal circuit block diagram of a prime motion detector according to a fourth embodiment of the present invention.

FIG. 12A and FIG. 12B are side views of an assistant motion detector according to a preferred embodiment of the present invention.

FIG. 12C is an internal circuit block diagram of an assistant motion detector according to a preferred embodiment of the present invention.

FIG. 13 is an internal circuit block diagram of a receiver according to an embodiment of the present invention.

FIG. 14 is a flowchart illustrating a method for processing a detecting data according to an embodiment of the present invention.

FIG. 15 is a flowchart illustrating a method for processing a detecting data according to another embodiment of the present invention.

### DESCRIPTION OF EMBODIMENTS

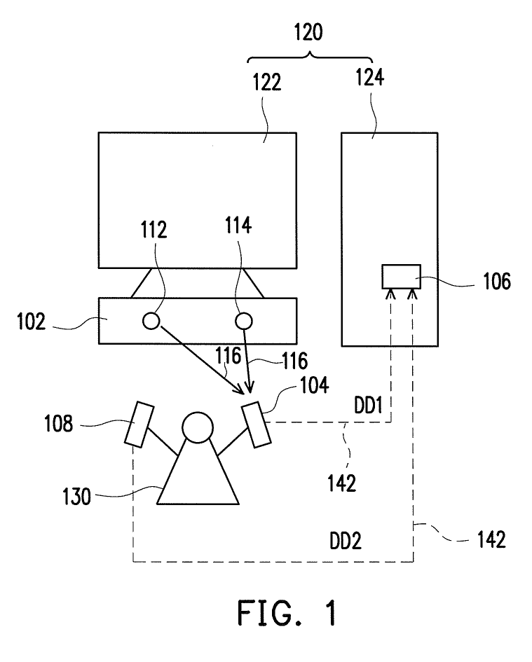

FIG. 1 is a schematic diagram illustrating an input apparatus of a computer system according to a preferred embodiment of the present invention. Referring to FIG. 1, the input apparatus of the present embodiment includes an image object 102, a prime motion detector 104 and a receiver 106. The image object 102 includes a plurality of positioning light sources 112 and 114, which are used for providing a light beam 116 having a first wavelength. In the present embodiment, the image object 102 can be disposed together with a screen 122 of the computer system 120. Moreover, the prime motion detector 104 can detect the image object 102 and sense an action of a user 130 to generate a detecting data DD1. Wherein, the prime motion detector 104 can transmit the detecting data to the receiver 106 via a wireless transmission path 142. By such means, the receiver 106 can transmit the detecting data DD1 to a host 124 of the computer system 120, so that the computer system 120 can be operated according to the detecting data DD1. In the present embodiment, the image object 102 includes a plurality of light sources 112 and 114 for providing the light beam 116.

Besides the prime motion detector 104, in some other embodiments, the input apparatus may further include an assistant motion detector 108. Similarly, the assistant motion detector 108 can also receive the light beam 116 generated by the positioning light sources 112 and 114, and sense an action of the user 130 to generate a detecting data DD2. Similarly, the assistant motion detector 108 can also transmit the detecting data DD2 to the host 124 via the wireless transmission path 142.

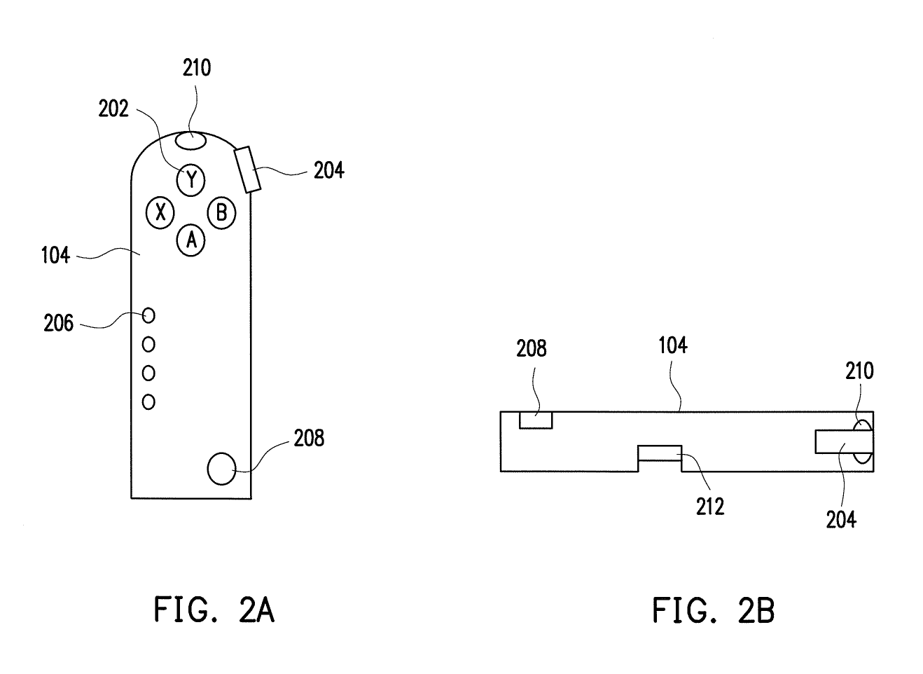

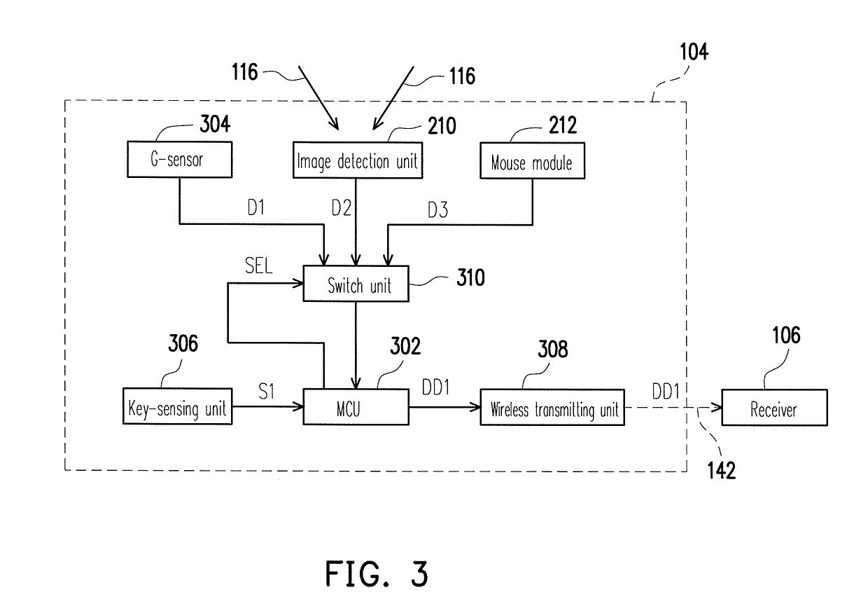

FIG. 2A is a top view of a prime motion detector according to an embodiment of the present invention. FIG. 2B is a side view of a prime motion detector according to an embodiment of the present invention. Referring to FIG. 2A and FIG. 2B, the prime motion detector 104 may have a plurality of function keys 202, 204, 206 and 208. When a certain function key is pressed, a corresponding operation of the prime motion detector 104 is performed. For example, when the function key 208 is pressed, it represents power of the prime motion detector 104 is activated.

Moreover, the prime motion detector 104 further includes an image detection unit 210 and a mouse module 212. The image detection unit 210 is for example a light sensor which may detect the light beam 116 emitted from the light sources 112 and 114 in the image object 102 of FIG. 1. By such means, the prime motion detector 104 can detect a relative position between itself and the image object 102. Moreover, the mouse module 212 is applied in the prime motion detector 104 to implement an optical mouse operation mode. In the following content, several embodiments for internal circuits of the prime motion detector 104 are provided, though those skilled in the art should understand that the present invention is not limited thereto.

### First Embodiment

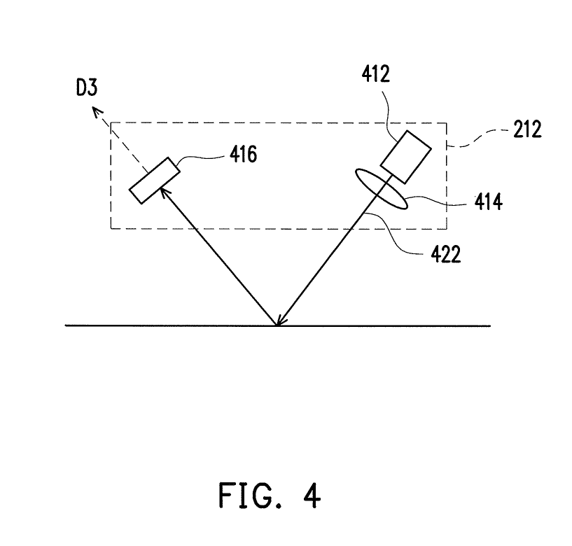

FIG. 3 is an internal circuit block diagram of a prime motion detector according to a first embodiment of the present invention. Referring to FIG. 3, the prime motion detector 104 includes a micro control unit (MCU) 302, a G-sensor 304, a key-sensing unit 306, a wireless transmitting unit 308, a switch unit 310, an image detection unit 210 and a mouse module 212. In the present embodiment, the G-sensor 304 is an accelerometer. In other embodiment, the G-sensor 304 is for example, a combination of an accelerometer and/or a gyroscope. An input terminal of the switch unit 310 is coupled to output terminals of the image detection unit 210, the G-sensor 304 and the mouse module 212, and an output terminal of the switch unit 310 is coupled to the MCU 302. Moreover, the MCU 302 is coupled to the key-sensing unit 306 and the wireless transmitting unit 308. In the present embodiment, the wireless transmitting unit 308 can be coupled to the receiver 106 via the wireless transmission path 142, and the wireless transmission path 142 can be an infrared transmission path, a blue-tooth transmission path or a wireless network transmission path.

In the present embodiment, the MCU 202 further outputs a selection signal SEL to the switch unit 310, so that the switch unit 310 can determine an output data according to a state of the selection signal SEL. For example, when the selection signal SEL has a first state, the switch unit 310 can transmit an output D1 of the G-sensor 304 and an output D2 of the image detection unit 210 to the MCU 302. Comparatively, when the selection signal SEL has a second state, the switch unit 310 can transmit an output D3 of the mouse module 212 to the MCU 302.

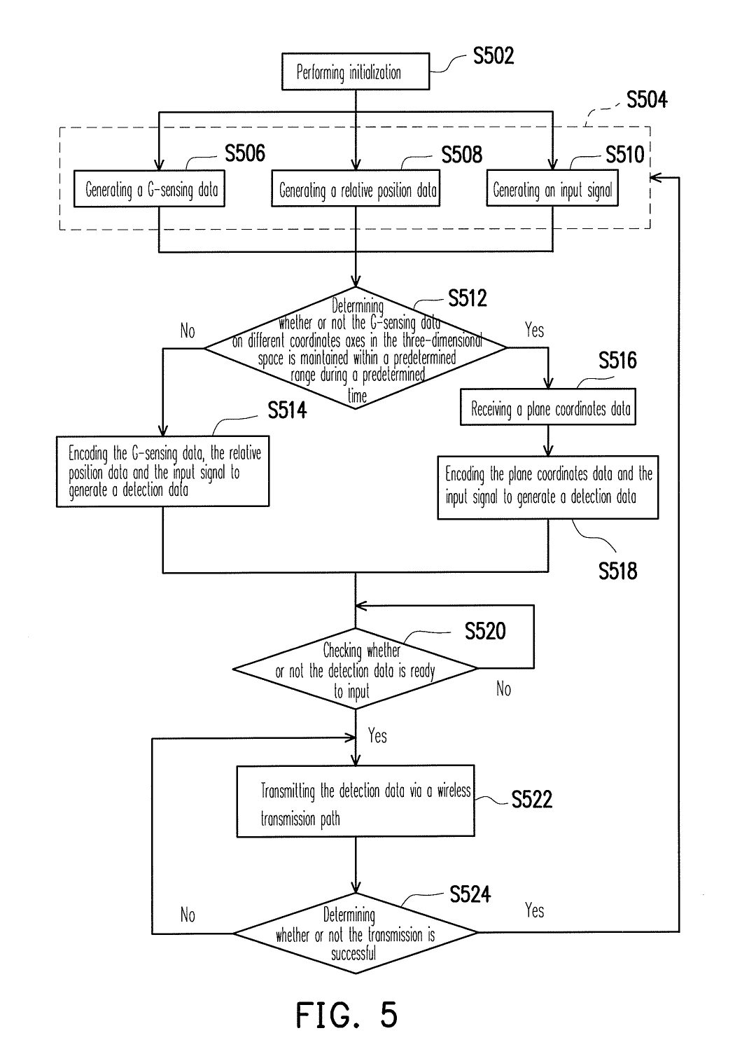

FIG. 4 is a structural diagram of a mouse module. Referring to FIG. 4, the mouse module 212 includes a light-emitting source 412, an optical lens 414 and a light-sensing unit 416. The light-emitting source 412 can be a laser diode or a light-emitting diode, which can output a light beam 422 having a predetermined wavelength. The optical lens 414 is disposed on a transmission path of the light beam 422 for focusing the light beam 422. When the light beam 422 reaches a plane, it is reflected back to the mouse module 212. Now, the light-sensing unit 416 receives the reflection light of the light beam 422 and output a plane coordinates data D3 to the switch unit 310.

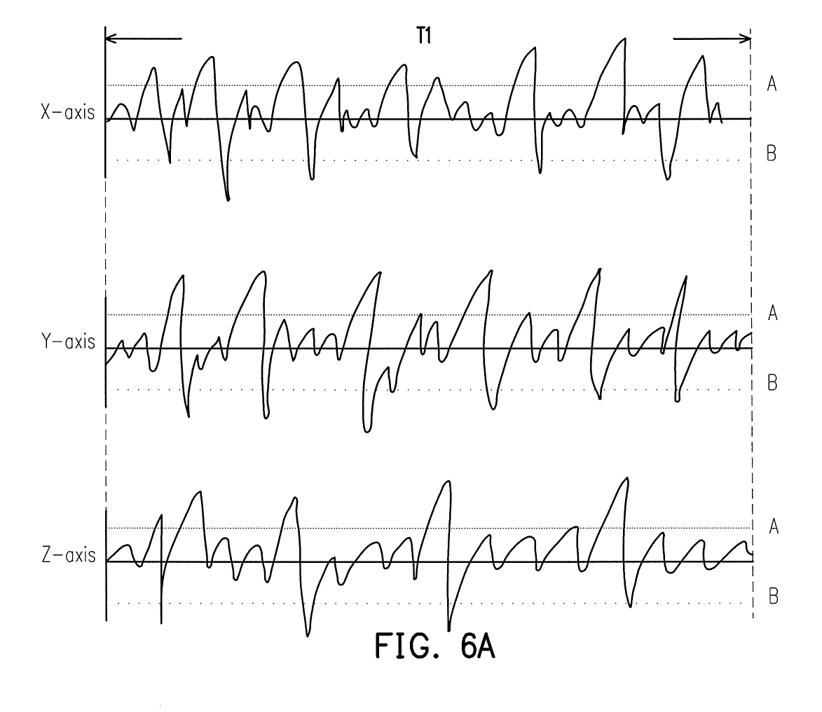

FIG. 5 is a flowchart illustrating a method for detecting a movement state of an prime motion detector according to a first embodiment of the present invention. Referring to FIG. 3 and FIG. 5, when the power of the MSD 104 is activated, in step S502, initialization is performed. Next, in step S504, the MCU 302 generates a detecting data DD1 according to a movement state of the prime motion detector 104 in the three-dimensional space.

To be specific, in the step S504, the G-sensor 304 may detect accelerations of the prime motion detector 104 on different coordinates axes in the three-dimensional space, and in step 506, a G-sensing data D1 on each coordinate axis is generated to the switch unit 310. Moreover, the key-sensing unit 306 may detect a state of each key on the prime motion detector 104. When one of the keys is enabled, the key-sensing unit 306 generates a corresponding input signal S1 (step S508) to the switch unit 310. On the other hand, when the light-sensing unit 210 receives the light beam 116 sent from the light sources 112 and 114 (shown as FIG. 1), in step S510, the light-sensing unit 210 generates a relative position data D2 to the MCU 302.

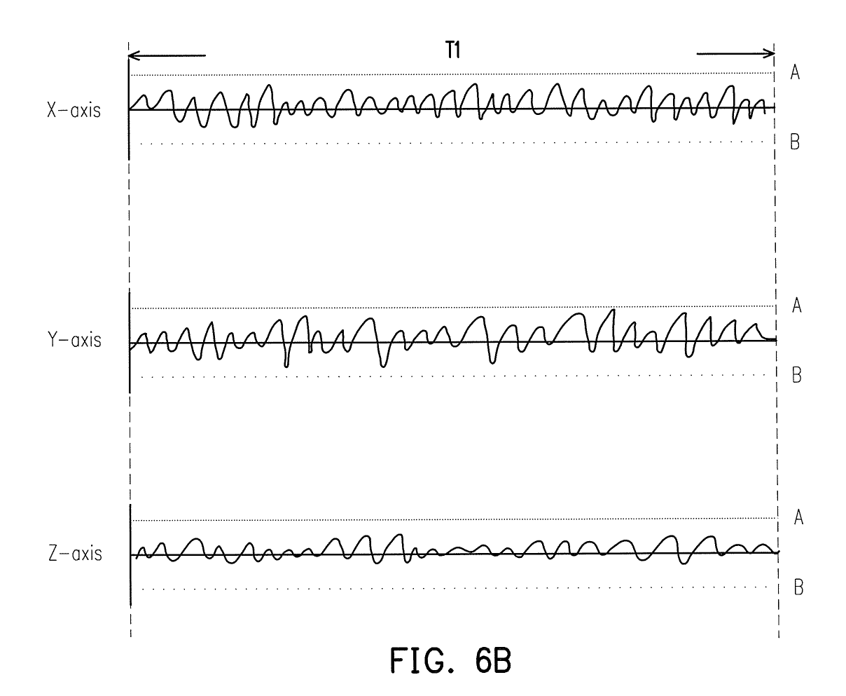

Assuming an initial state of the selection signal SEL is the first state, and accordingly the switch unit 310 may transmit the G-sensing data D1 and the relative position data D2 to the MCU 302. Next, in step S512, the MCU 302 determines whether or not the G-sensing data D1 on different coordinates axes in the three-dimensional space output from the G-sensor 304 is maintained to a predetermined range within a predetermined time. If the G-sensing data output from the G-sensor 304 is as that shown in FIG. 6A, and within a predetermined time T1, the G-sensing data on different coordinates axes in the three-dimensional space are not all within the predetermined range (less than a predetermined value A, and greater than a predetermined value B), the MCU 302 then confirms that the prime motion detector 104 is moved in the three-dimensional space. Now, the MCU 302 can encode the G-sensing data D1, the relative position data D2 and the input signal S1 to generate the detecting data DD1, as that described in step S514.

Comparatively, when the G-sensing data output from the G-sensor 304 is as that shown in FIG. 6B, i.e. within the predetermined time T1, the G-sensing data on different coordinates axes in the three-dimensional space are all maintained within the predetermined range (less than the predetermined value A, and greater than the predetermined value B), the MCU 302 then confirms that the prime motion detector 104 is only moved on a two-dimensional plane. Therefore, the MCU 302 can activate the mouse module 212 and switch the state of the selection signal SEL to a second state. Now, the switch unit 310 can transmit the plane coordinates data D3 to the MCU 302. Next, in step S516, the MCU 302 receives the plan coordinates data D3. Next, in step S518, the MCU 302 encodes the plane coordinates data D3 and the input signal S1 to generate the detecting data DD1.

After the step S514 or the step S518 is completed, the MCU 302 outputs the detecting data DD1 to the wireless transmitting unit 308, and determines whether or not the wireless transmitting unit 308 is ready to transmit the detecting data DD1, as that described in step S520. Assuming the MCU 302 judges the wireless transmitting unit 308 cannot transmit the detecting data DD1 (i.e. “no” marked in the step S520) due to some reasons, such as relatively great interference on the wireless transmission path 142, the step S520 is then repeated until the MCU 302 judges the wireless transmitting unit 308 is ready to transmit the detecting data DD1 (i.e. “yes” marked in the step S520). Next, in step 522, the wireless transmitting unit 308 transmits the detecting data DD1 to the receiver 106 via the wireless transmission path 142. Moreover, in step S524, the MCU 302 further checks whether or not transmission of the detecting data DD1 is successful.

If the MCU 302 judges that transmission of the detecting data DD1 is not successful (i.e. “no” marked in the step S524), the step S522 is then repeated. Comparatively, if the MCU 302 judges that transmission of the detecting data DD1 is successful (i.e. “yes” marked in the step S524), the step S504 is then repeated for continually transmitting latest detecting data to the receiver 106.

### Second Embodiment

In a second embodiment of the present invention, in the step S512 of FIG. 5, the MCU 302 only judges whether the G-sensing data D1 on a height-axis (z-axis) in the three-dimensional space is within the predetermined range. If the MCU 302 detects the G-sensing data D1 on the height-axis in the three-dimensional space is maintained within the predetermined range, the MCU 302 then confirms that the prime motion detector 104 is only moved on the two-dimensional plane. Now, the MCU 302 can also switch the selection signal SEL to the second state, and the step S516 and so on are executed.

### Third Embodiment

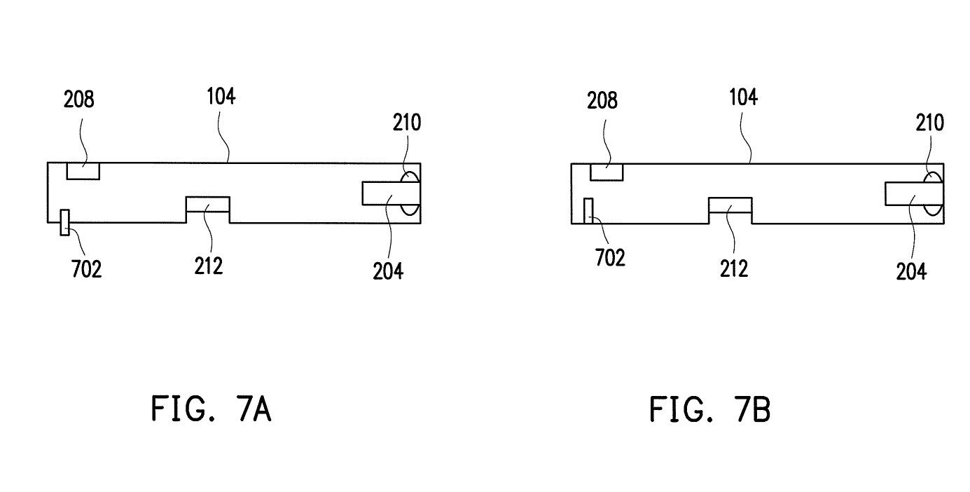

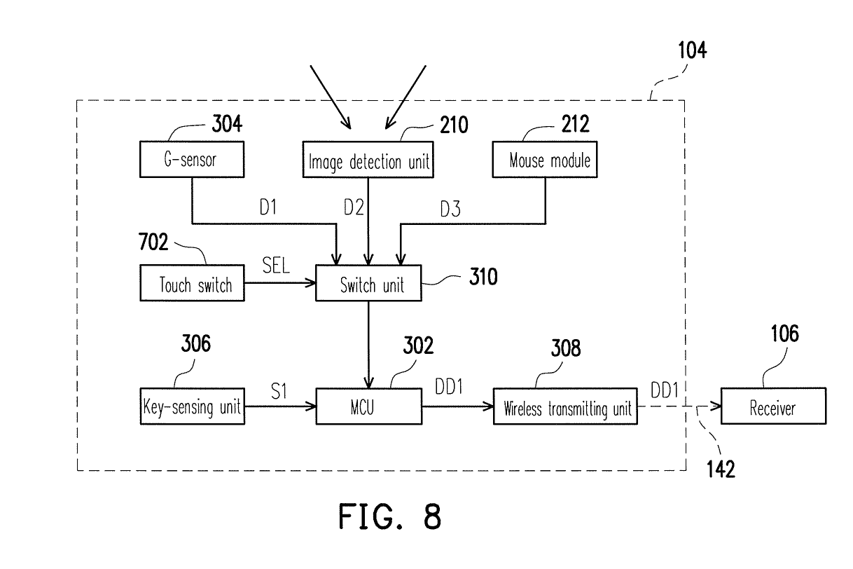

FIG. 7A and FIG. 7B are side views of a prime motion detector according to a third embodiment of the present invention. FIG. 8 is an internal circuit block diagram of a prime motion detector according to a third embodiment of the present invention. Referring to FIG. 7A and FIG. 8 first, in the present embodiment, the prime motion detector 104 further has a touch switch 702. The touch switch 702 can output the selection signal SEL having a different state to the MCU 302 according to its own state.

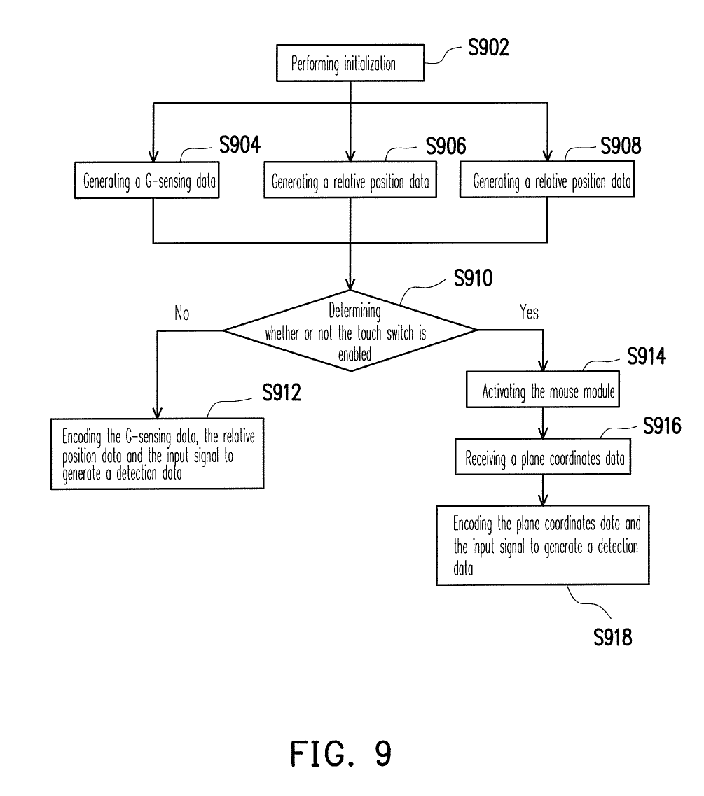

FIG. 9 is a flowchart illustrating a method for generating a detecting data according to a third embodiment of the present invention. Referring to FIG. 8 and FIG. 9, as described in the first embodiment, when the prime motion detector 104 is activated, initialization is performed (S902), and the G-sensor 304, the image detection unit 210 and the key-sensing unit 306 can respectively generate the corresponding G-sensing data D1, the relative position data D2 and the input signal S1 as that described in steps S904, S906 and S908. Next, in step S910, whether or not the touch switch 702 is enabled is determined. If the touch switch 702 is not enabled as that shown in FIG. 7A (i.e. “no” marked in the step S910), the touch switch 702 then outputs the selection signal SEL having the first state to the switch unit 310, so that the switch unit 310 can transmit the G-sensing data D1 and the relative position data D2 to the MCU 302. Next, in step S912, the MCU 302 encodes the G-sensing data D1, the relative position data D2 and the input signal S1 to generate the detecting data DD1.

Comparatively, when the prime motion detector 104 is taken as an optical mouse and is moved on a plane, the touch switch 702 is then enabled as that shown in FIG. 7B, and outputs the selection signal SEL having the second state to the switch unit 310. Now, the switch unit 310 can transmit an output of the mouse module 212 to the MCU 302. Moreover, in step S914, the MCU 302 can activate the mouse module 212, and in step S916, the MCU 302 receives the plane coordinates data D3 output from the mouse module 212. Next, in step S918, the MCU 302 encodes the plane coordinates data D3 and the input signal S1 to generate the detecting data DD1.

### Fourth Embodiment

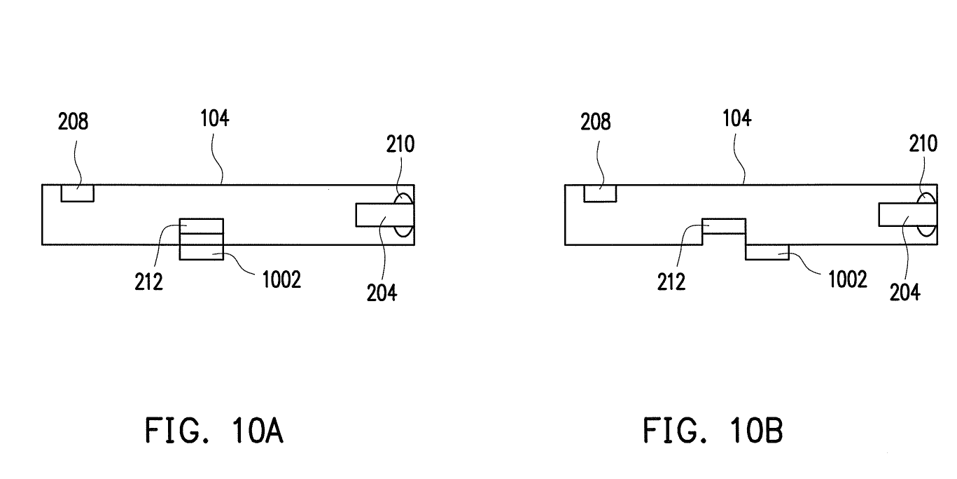

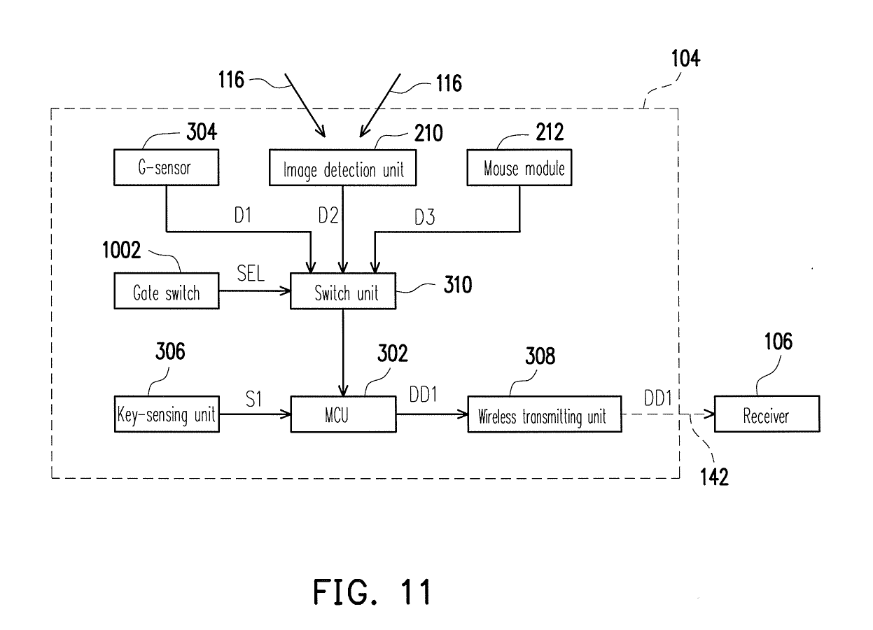

FIG. 10A and FIG. 10B are side views of a prime motion detector according to a fourth embodiment of the present invention. FIG. 11 is an internal circuit block diagram of a prime motion detector according to a fourth embodiment of the present invention. Referring to FIG. 10A and FIG. 11 first, in the present embodiment, the prime motion detector 104 may have a gate switch 1002. State of the gate switch 1002 determines the state of the selection signal SEL.

When the gate switch 1002 is closed, the selection signal SEL having the first state is output to the switch unit 310, so that the switch unit 310 can transmit the G-sensing data D1 and the relative position data D2 to the MCU 302. Comparatively, when the prime motion detector 104 is utilized as the optical mouse, the gate switch 1002 is then opened as that shown in FIG. 10B. Now, the gate switch 1002 outputs the selection signal SEL having the second state to the switch unit 310, so that the switch unit 310 can transmit the plane coordinates data D3 to the MCU 302.

### Fifth Embodiment

Referring to FIG. 4 again, in the fifth embodiment, the selection signal SEL is determined by the mouse module 212. In detail, the state of the selection signal SEL is determined according to an output of the light-sensing unit 416. When the light-sensing unit 416 cannot receive the reflection light of the light beam 422 within a predetermined time, the light-sensing unit 416 changes the state of the selection signal SEL to the first state. Comparatively, when the prime motion detector 104 is taken as the optical mouse and is operated on a plane, the light-sensing unit 416 then receives the reflection light of the light beam 422. Now, the light-sensing unit 416 can change the state of the selection signal SEL to the second state. Accordingly, the switch unit 310 can select and output different signals to the MCU 302 according to the state of the selection signal SEL.

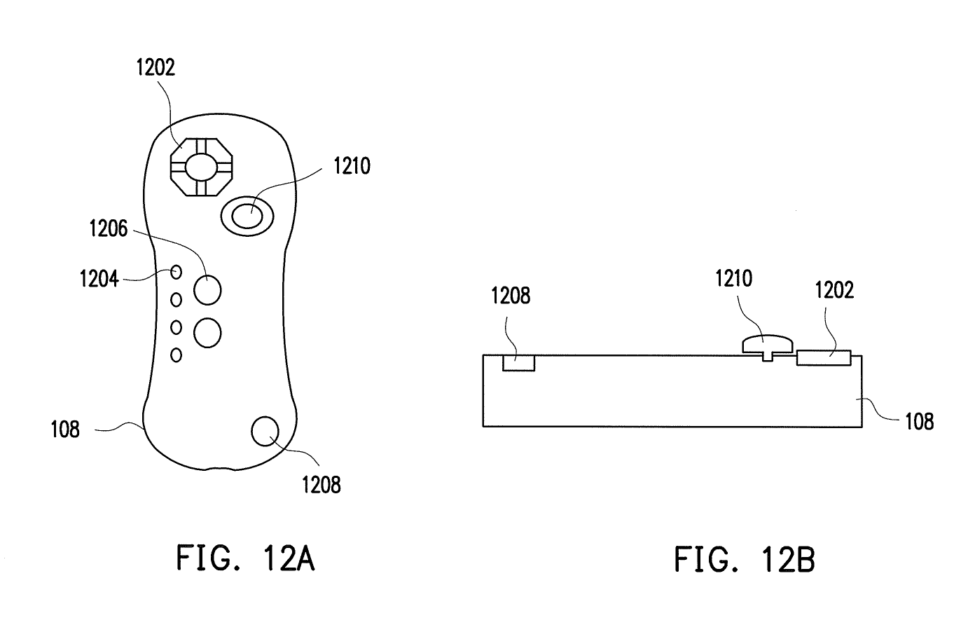

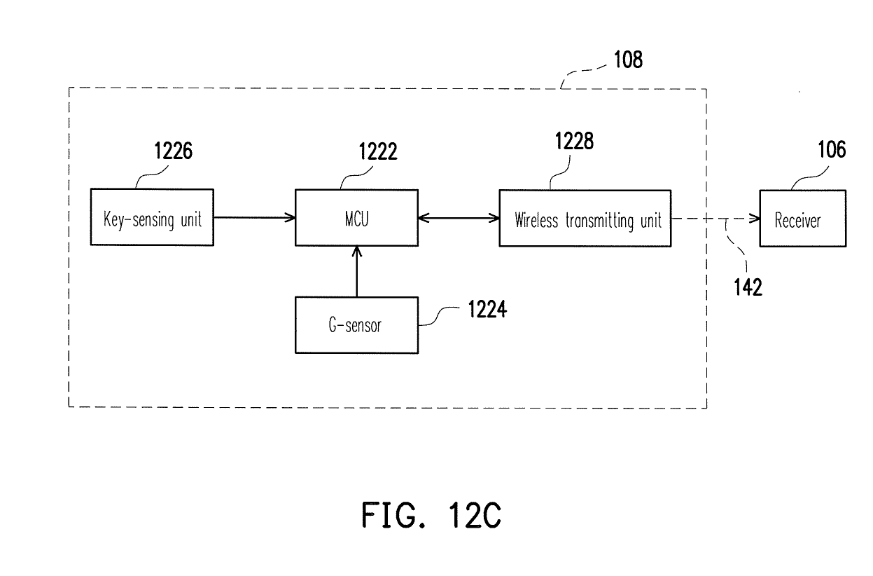

FIG. 12A and FIG. 12B are side views of an assistant motion detector according to a preferred embodiment of the present invention. Referring to FIG. 12A and FIG. 12B, similar to the prime motion detector 104, the assistant motion detector 108 of the present embodiment also has a G-sensor for detecting a movement state of the assistant motion detector 108 in the three-dimensional space, and outputting a second detecting data. Structure and principle of the assistant motion detector 108 are similar to that of the prime motion detector 104.

A plurality of function keys 1202, 1204, 1206 and 1208 are disposed on the assistant motion detector 108. Wherein, the key 1202 is a 4-way navigation key, and the key 1208 is for example a power key. Particularly, a joystick 1210 can be disposed on the assistant motion detector 108.

FIG. 12C is an internal circuit block diagram of an assistant motion detector according to a preferred embodiment of the present invention. Referring to FIG. 12C, the internal circuit of the assistant motion detector 108 is similar to that of the prime motion detector 104, which also includes a MCU 1222, a G-sensor 1224, a key-sensing unit 1226 and a wireless transmitting unit 1228. The MCU 1222 is coupled to the G-sensing unit 1224, the key-sensing unit 1226 and the wireless transmitting unit 1228, and the wireless transmitting unit 1228 is coupled to the receiver 106 via the wireless transmission path 142. The characteristic and principle of the assistant motion detector 108 are similar to that of the prime motion detector 104, a difference there between is that the joystick 1210 is disposed on the assistant motion detector 108. Therefore, besides the states of the flnction keys on the assistant motion detector 108 are detected, the key-sensing unit 1226 further detects a state of the joystick 1210 and generates a corresponding input signal.

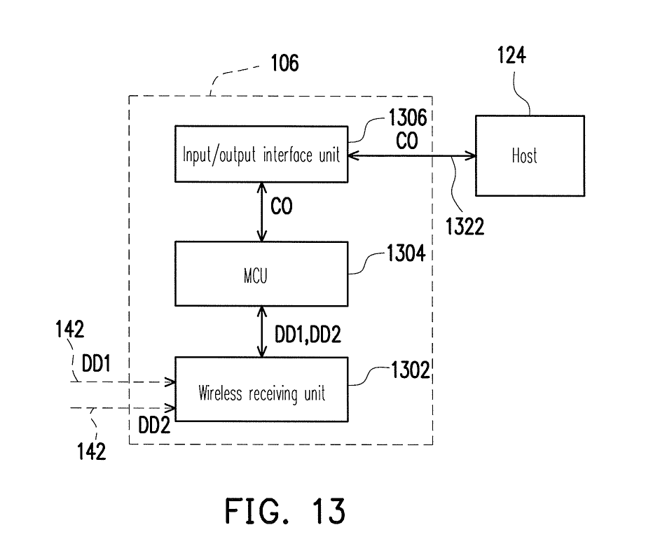

FIG. 13 is an internal circuit block diagram of a receiver according to a preferred embodiment of the present invention. Referring to FIG. 13, the receiver 106 includes a wireless receiving unit 1302, a MCU 1304 and an input/output interface unit 1306. The MCU 1304 is coupled to the wireless receiving unit 1302 and the input/output interface unit 1306. Moreover, the wireless receiving unit 1302 can receive the detecting data DD1 and DD2 via the wireless transmission path 142, and the input/output interface unit 1306 is coupled to the host 124 via a transmission interface 1322. In the present embodiment, the transmission interface 1322 includes a universal serial bus (USB), an IEEE 1394, a serial interface, a parallel interface, and a PCMCIA. Comparatively, the input/output interface unit 1306 can be implemented by different interfaces according to a type of the transmission interface 1322.

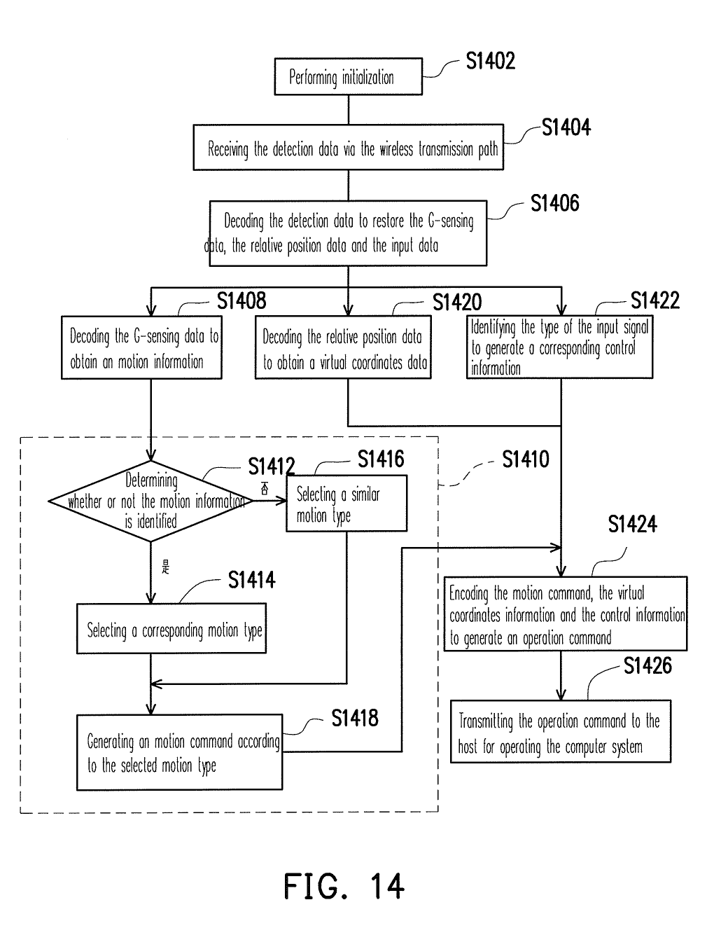

FIG. 14 is a flowchart illustrating a method for processing a detecting data according to an embodiment of the present invention. Referring to FIG. 13 and FIG. 14, when the receiver 106 is connected to the host 124 of the computer system 120, and is enabled, in step S1402, the receiver 106 is initialized, for example, establishing a wireless transmission path 322 with the prime motion detector 104 of FIG. 1, or verifying the prime motion detector 104 and the assistant motion detector 108. After the receiver 106 is initialized, in step S1404, the wireless receiving unit 1302 receives the detecting data DD1 or DD2 via the wireless transmission path 142. Now, the wireless receiving unit 1302 can transmit the detecting data DD1 or DD2 to the MCU 1304. Next, in step S1406, the detecting data DD1 or DD2 is decoded. Taking the detecting data DD1 as an example, when the prime motion detector 104 is operated in the three-dimensional space, after the detecting data DD1 is decoded, the original G-sensing data D1, the relative position data D2 and the input signal S1 (shown in FIG. 3) are then generated.

Next, the MCU 1304 further decodes the G-sensing data D1 to obtain a motion information (step S1408). The motion information includes accelerations of the G-sensor 304 on different coordinates axes in the three-dimensional space. Moreover, in step S1410, the MCU 1304 generates a motion command.

In detail, after the MCU 1304 obtains the motion information, in step S1412, whether or not the motion information can be identified is determined. If the MCU 1304 can identify such motion information (i.e. “yes” marked in the step S1412), in step S1414, a corresponding motion type is selected, for example, a straight line or an arc line movement behaviour. Moreover, if the MCU 1304 cannot identify the motion information (i.e. “no” marked in the step S1412), in step S1416, a similar motion type is then selected according to calculated motion types. Accordingly, the MCU 1304 generates the motion command according to the selected motion type.

Besides decoding the G-sensing data D1, in step S1420, the MCU 1304 further decodes the relative position data D2 to obtain a virtual coordinates information. Next, in step SI 422, a type of the input signal generated by pressing a key on the prime motion detector 104 is identified, so as to generate a corresponding control information. Next, in step S1424, the MCU 1304 encodes the motion command, the virtual coordinates information and the control information to generate an operation command CO to the input/output interface unit 1306. After the input/output interface unit 1306 receives the operation command CO, the operation command CO can be transmitted to the host 124 via the transmission interface 122, so that the computer system 120 can be operated according to the operation command CO.

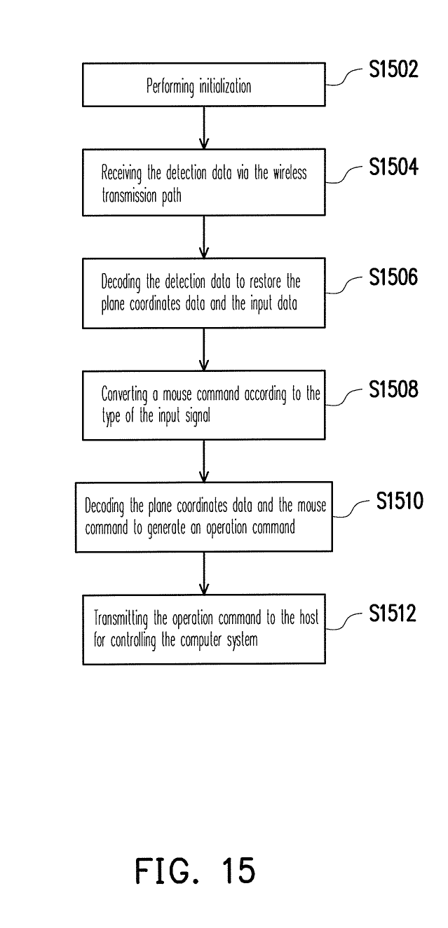

FIG. 15 is a flowchart illustrating a method for processing a detecting data according to another embodiment of the present invention. Referring to FIG. 13 and FIG. 15, in the present embodiment, when the receiver 106 is enabled, in step S1502, the receiver 106 is also initialized. Next, in step S1504, the wireless receiving unit 1302 also receives the detecting data DD1 or DD2 via the wireless transmission path 142. In the present embodiment, assuming the wireless receiving unit 1302 receives the detecting data DD1 and transmits it to the MCU 1304. Next, in step S1506, the MCU 1304 decodes the detecting data DD1. If the prime motion detector 104 is operated as the optical mouse, namely, if the prime motion detector 104 is only moved on the two-dimensional plane, the plane coordinates data and the input signal are then obtained after the detecting data DD1 is decoded.

Next, in step S1508, the MCU 1304 converts a mouse command according to the type of the input signal. For example, when the key 202 (shown in FIG. 2A) on the prime motion detector 104 is pressed, the MCU 1304 then determines that a left button of the mouse is pressed and generates the corresponding mouse command. Next, in step S1510, the MCU 1304 encodes the plane coordinates data and the selected mouse command to generate the operation command CO. Next, in step S1512, the MCU 1304 transmits the operation command CO to the input/output interface unit 1306, and then the operation command CO is transmitted to the host 124 via the transmission interface 1322 for controlling the computer system 120.

In summary, the present invention has at least the following advantages:

1. The prime motion detector and assistant motion detector of the present invention respectively include the image detection unit and the G-sensor, which can detect a movement state of the action detector. Therefore, when the user operates the computer system, he may have a more convenient, realistic and intuitive feeling.

2. Moreover, since the receiver of the present invention is connected to the computer system via a universal transmission interface such as a USB, an IEEE 1394, a serial interface, a parallel interface, and a PCMCIA, etc., the present invention can be applied to various computer systems, not only the fixed host. Besides, during the initialization, different motion types are set for operating the computer system. Therefore, the present invention is suitable for various application software.

3. According to another aspect, since the prime motion detector includes the mouse module, the prime motion detector can be operated as a wireless optical mouse, so that utilization of the present invention can be more flexible, practicable and diversified.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An input apparatus for a computer system, comprising:
an image object;
a prime motion detector, including a first G-sensor, an image detection unit and an optical mouse module, the prime motion detector detecting its own movement state in a three-dimensional space or a two-dimensional plane, and outputting a first detecting data, wherein the image detection unit is used for detecting the image object; and
a receiver, coupled to the computer system via a transmission interface, for receiving the first detecting data via a wireless transmission path, so as to generate a corresponding computer operation data according to the first detecting data, and transmit the computer operation data to the computer system via the transmission interface.

2. The input apparatus for a computer system as claimed in claim 1, wherein the prime motion detector further comprises:
a plurality of first keys;
a first key-sensing unit, for detecting a state of each first key to output a corresponding input signal;
a switch unit, coupled to the image detection unit, the first G-sensor and the optical mouse module, respectively;
a first micro control unit (MCU), coupled to the first key-sensing unit and the switch unit, for encoding the input signal and an output of the switch unit to generate the first detecting data; and
a first wireless transmitting unit, coupled to the first MCU for receiving the first detecting data, and transmitting the first detecting data to the receiver via the wireless transmission path,
wherein the switch unit determines to transmit an output of the optical mouse module, or outputs of the image detection unit and the first G-sensor to the first MCU according to a selection signal.

3. The input apparatus for a computer system as claimed in claim 1, wherein the receiver comprises:
a wireless receiving unit, for receiving the first detecting data via the wireless transmission path;
a MCU, coupled to the wireless receiving unit for decoding the first detecting data and generating the computer operation data; and
an input/output interface unit, coupled to the computer system via the transmission interface, and coupled to the MCU, for transmitting the computer operation data to the computer system via the transmission interface.

4. The input apparatus for a computer system as claimed in claim 1, wherein the transmission interface comprises a universal serial bus (USB), an IEEE 1394, a serial interface, a parallel interface, and a PCMCIA.

5. The input apparatus for a computer system as claimed in claim 1 further comprising an assistant motion detector having a second G-sensor, for detecting a movement state of the assistant motion detector in a three-dimensional space, and outputting a second detecting data.

6. The input apparatus for a computer system as claimed in claim 5, wherein the assistant motion detector further comprises:
a plurality of second keys;
a joystick;
a second key-sensing unit, for detecting a state of each second key and a state of the joystick, so as to output a corresponding second input signal;
a second MCU, coupled to the second key-sensing unit and the second G-sensor, respectively, for encoding the second input signal and an output of the second G-sensor to generate the second detecting data; and
a second wireless transmitting unit, coupled to the second MCU for receiving the second detecting data, and transmitting the second detecting data to the receiver via the wireless transmission path.

7. A multifunction optical mouse, adapted to a computer system, wherein the computer system having a receiver, the optical mouse comprising:
an image detection unit, for detecting an image object, and outputting a relative position data;
a G-sensor, for detecting a movement state of the optical mouse in a three-dimensional space, so as to output a G-sensing data on each coordinate axis in the three-dimensional space;
a mouse module, for detecting a movement state of the optical mouse on a plane, and outputting a plane coordinates data;
a switch unit, coupled to the image detection unit, the G-sensor and the mouse module, respectively, for outputting the plane coordinates data or the relative position data and the G-sensing data according to a selection signal;
a MCU, coupled to the switch unit, for encoding at least an input signal and an output of the switch unit to generate a first detecting data; and
a wireless transmitting unit, coupled to the MCU for receiving the first detecting data, and transmitting the first detecting data to the receiver via a wireless transmission path.

8. The multifunction optical mouse as claimed in claim 7, wherein when the selection signal is in a first state, the switch unit selects to transmit outputs of the image detection unit and the G-sensor to the MCU.

9. The multifunction optical mouse as claimed in claim 7, wherein when the MCU detects that within a predetermined time, and the G-sensing data on each coordinate axis in the three-dimensional space output from the G-sensor is maintained within a predetermined range, the MCU switches the selection signal to a second state, so that the switch unit selects to transmit the plane coordinates data to the MCU.

10. The multifunction optical mouse as claimed in claim 7, wherein when the MCU detects that the G-sensing data on a height-axis in the three-dimensional space output from the G-sensor is maintained within a predetermined range, the MCU switches the selection signal to the second state, so that the switch unit selects to transmit the plane coordinates data to the MCU.

11. The multifunction optical mouse as claimed in claim 7 further comprising a touch switch, the output terminal of the touch switch is coupled to the switch unit, wherein when the touch switch is disabled, the selection signal then is output in a first state, so that the switch unit selects to transmit the relative position data and the G-sensing data to the MCU,
when the touch switch is enabled, the selection signal is then output in a second state, so that the switch unit selects to transmit the plane coordinates data to the MCU.

12. The multifunction optical mouse as claimed in claim 7 further comprising a gate switch coupled to the switch unit, wherein when the gate switch is closed, the gate switch outputs the selection signal in a first state, so that the switch unit selects to transmit the relative position data and the G-sensing data to the MCU,
when the gate switch is opened, the gate switch outputs the selection signal in a second state, to that the switch unit selects to transmit the plane coordinates data to the MCU.

13. The multifunction optical mouse as claimed in claim 7, wherein the mouse module further comprises:
a light-emitting, for outputting a light beam with a predetermined wavelength;
an optical lens, disposed at an output terminal of the light-emitting source, and located at a transmission path of the light beam, for focusing the light beam having the predetermined wavelength; and
a light-sensing unit, having an output terminal coupled to an input terminal of the switch unit, for sensing a reflection light of the light beam having the predetermined wavelength, and outputting the plane coordinates data to the switch unit.

14. The multifunction optical mouse as claimed in claim 13, wherein when the light-sensing unit does not sense the reflection light of the light beam having the predetermined wavelength, the selection signal is in a first state, so that the switch unit selects to transmit the relative position data and the G-sensing data to the MCU,
when the light-sensing unit senses the reflection light of the light beam having the predetermined wavelength, the selection signal is in a second state, to that the switch unit selects to transmit the plane coordinates data to the MCU.

15. A method for operating a computer system, comprising:
detecting a movement state of an operation part in a three-dimensional space via a G-sensor, and generating a G-sensing data corresponding to each coordinate axis of the three-dimensional space;
detecting relative positions between a plurality of positioning light sources and the operation part to generate a relative position data;
detecting a movement state of the operation part in the two-dimensional plan to generate a plane coordinates data, when the operation part is determined to be only moved in a two-dimensional plane,; and
encoding the plane coordinates data, or encoding the G-sensing data and the relative position data to generate a detecting data for operating the computer system.

16. The method for operating a computer system as claimed in claim 15 further comprising:
transmitting the detecting data from the operation part to a receiver via a wireless transmission path; and
transmitting the detecting data from the receiver to a computer system via a transmission interface, so as to operate the computer system according to the detecting data.

17. The method for operating a computer system as claimed in claim 15, wherein steps of detecting whether the operation part is only moved on the two-dimensional plane comprise:
determining whether or not the G-sensing data of the operation part on each coordinate axis in the three-dimensional space is maintained within a predetermined range during a predetermined time;
determining the operation part is only moved on the two-dimensional plane, when the G-sensing data of the operation part on each coordinate axis in the three-dimensional space is maintained within the predetermined range during the predetermined time; and
determining the operation part is only moved in the three-dimensional plane, when the G-sensing data of the operation part on each coordinate axis in the three-dimensional space is not maintained within the predetermined range during the predetermined time.

18. The method for operating a computer system as claimed in claim 15, wherein steps of detecting whether the operation part is only moved on the two-dimensional plane comprise:
determining whether or not the G-sensing data of the operation part on a height-axis in the three-dimensional space is maintained within a predetermined range;
determining the operation part is only moved on the two-dimensional plane, when the G-sensing data of the operation part on the height-axis in the three-dimensional space is maintained within the predetermined range; and
determining the operation part is only moved in the three-dimensional plane, when the G-sensing data of the operation part on the height-axis in the three-dimensional space is not maintained within the predetermined range.

19. The method for operating a computer system as claimed in claim 15, wherein steps of detecting whether the operation part is only moved on the two-dimensional plane comprise:
providing a switch in the operation part; and
detecting a state of the switch, for determining whether or not the operation part is only moved on the two-dimensional plane.

20. The method for operating a computer system as claimed in claim 15 further comprising providing a light source for outputting a light beam having a predetermined wavelength, so as to detect a movement state of the operation part on the two-dimensional plane.
